(19) United States
(12) Patent Application Publication
(10) Pub. No.: US 2005/0162087 A1
(43) Pub. Date: Jul. 28, 2005

(54) Plasma display panel

(75) Inventors: Young-sun Kim, Suwon-si (KR); Chang-wan Hong, Yongin-si (JP); Young-soo Han, Suwon-si (KR); Chung-wook Roh, Seoul (KR); Hye-jeong Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/965,284

(22) Filed: Oct. 15, 2004

(30) Foreign Application Priority Data
Oct. 22, 2003 (KR) 03-73840

(51) Int. Cl. H01J 17/49

(52) U.S. Cl. 313/587; 313/582

(57) ABSTRACT

A plasma display panel is provided, including lower and upper substrates separated from each other to form a discharge space therebetween. A plurality of partitions are provided between the lower and upper substrates to partition the discharge space to define the discharge cells, and a plurality of first and second discharge electrodes generate a discharge within the discharge cells. A plurality of fluorescent layers are provided to inner surfaces of the discharge cells, each of the fluorescent layers being exited by the discharge to generate visible rays of light, and a plurality of light shielding elements are provided to the upper substrate to prevent external rays of light from entering the discharge cells, wherein a plurality of light focusing elements provided to the upper substrate focus the visible rays of light generated in the discharge cells and emit the visible light.

### BACKGROUND OF THE INVENTION

This application claims the priority of Korean Patent Application No. 2003-73840, filed on Oct. 22, 2003, in the Korean Intellectual Property Office, the disclosure of which is incorporated herein in its entirety by reference.

1. Field of the Invention

The present invention generally relates to a plasma display panel, and more particularly, to a plasma display panel having an enhanced structure capable of improving brightness and bright room contrast.

2. Description of the Related Art

A plasma display panel using an electrical discharge to form an image has good display performance in brightness and viewing angle such that its use is increasing. In the plasma display panel, gas discharge is generated in a gas filled between electrodes by applying a DC or AC voltage on the electrodes, and ultraviolet rays of light involved in the gas discharge excite a fluorescent material to emit visible rays of light.

The plasma display panel is classified into DC and AC plasma display panels depending on types of discharge. In the DC plasma display panel, all electrodes are exposed in a discharge space, and a discharge is generated by electrical charges directly moving between electrodes. On the other hand, in the AC plasma display panel, at least one electrode is covered with a dielectric layer, and a discharge is generated by wall charges instead of electrical charges directly moving between the electrodes.

In addition, the plasma display panel is classified into facing and surface discharge plasma display panels depending on its arrangement of electrodes. In the facing discharge plasma display panel, two sustaining electrodes provided on front and rear substrates, respectively, face each other, and a discharge is generated in a direction perpendicular to the substrates. On the other hand, in the surface discharge plasma display panel, a pair of sustaining electrodes is provided on the same substrate, and a discharge is generated on a surface of the substrate.

Although it has high luminous efficiency, the facing discharge plasma display panel has a disadvantage in that its fluorescent layer can be easily deteriorated due to plasma particles. Therefore, the surface discharge plasma display panel has been mainly used.

### SUMMARY OF THE INVENTION

The present invention provides a plasma display panel capable of improving brightness and bright room contrast by enhancing a structure of an upper substrate of a surface discharge plasma display panel.

According to an exemplary embodiment of the present invention, there is provided a plasma display panel comprising: lower and upper substrates separated from each other forming a discharge space therebetween; a plurality of partitions provided between the lower and upper substrates partitioning the discharge space to define the discharge cells; a plurality of first and second discharge electrodes generating a discharge within the discharge cells; a plurality of fluorescent layers provided to inner surfaces of the discharge cells, each of the fluorescent layer being exited by the discharge to generate visible rays of light; and a plurality of light shielding elements provided to the upper substrate preventing external rays of light from entering the discharge cells, wherein a plurality of light focusing elements is provided to the upper substrate to focus the visible rays of light generated in the discharge cells and to emit the visible light.

An exemplary aspect of the present invention is to locate the first and second discharge electrodes on the surfaces of the light focusing elements.

Another exemplary aspect of the present invention is to form the light focusing elements to be convex on a lower surface of the upper substrate. In addition, the light focusing elements may be provided to the corresponding discharge cells.

Still another exemplary aspect of the present invention is to form the light focusing elements in strips on the lower surface of the upper substrate.

Still yet another exemplary aspect of the present invention is to provide light focusing elements in a direction perpendicular to the partitions.

Still yet another exemplary aspect of the present invention is to provide light shielding elements comprising a plurality of black strips provided in a predetermined interval on the upper substrate. In addition, the light focusing elements may be disposed to focus the visible rays of light generated in the discharge cells on regions between the black strips.

Still yet another exemplary aspect of the present invention is to subject upper surfaces of the black strips to a non-glare process.

Still yet another exemplary aspect of the present invention is to provide the black strips in a direction perpendicular to the partitions. In addition, the black strips may be provided on the upper surface of the upper substrate.

According to another exemplary embodiment of the present invention, there is provided a plasma display panel comprising: lower and upper substrates separated from each other to form a discharge space therebetween; a plurality of address electrodes provided in strips on an upper surface of the lower substrate; a first dielectric layer provided on the upper surface of the lower substrate to cover the address electrodes; a plurality of partitions provided on an upper surface of the first dielectric layer to partition the discharge space to define discharge cells; a plurality of first and second discharge electrodes provided on a lower surface of the upper substrate in a direction perpendicular to the address electrodes; a second dielectric layer provided on the lower surface of the upper substrate to cover the first and second discharge electrodes; a plurality of fluorescent layers provided on upper surfaces of the first dielectric layer and sidewalls of the partitions constituting inner surfaces of the discharge cells; and a plurality of light shielding elements provided to the upper substrate to prevent external rays of light from entering the discharge cells, wherein a plurality of light focusing elements are provided to the upper substrate to focus the visible rays of light generated in the discharge cells and emit the visible of light.

An exemplary aspect of the present invention is to provide the first and second discharge electrodes on a lower surface of the light focusing elements. In addition, the first and second discharge electrodes may extend in a longitudinal direction of the light focusing elements.

Another exemplary aspect of the present invention is to provide first and second bus electrodes on a lower surface of the first and second discharge electrodes. In addition, a protective layer may be provided on a lower surface of the second dielectric layer.

### BRIEF DESCRIPTION OF THE DRAWINGS

The above and other features and advantages of the present invention will become more apparent and readily appreciated from the following descriptions of the exemplary embodiments with reference to the attached drawings in which:

FIG. 1 is an exploded perspective view illustrating a surface discharge plasma display panel;

FIG. 2 is a cross sectional view of the surface discharge plasma display panel of FIG. 1;

FIG. 3 is an exploded perspective view illustrating an exemplary embodiment of a plasma display panel according to the present invention; and

FIG. 4 is a cross sectional view of the plasma display panel of FIG. 3.

### DETAILED DESCRIPTION OF THE INVENTION

The attached drawings for illustrating exemplary embodiments of the present invention are referred to in order to gain a sufficient understanding of the present invention, the merits thereof, and the objectives accomplished by the implementation of the present invention.

Hereinafter, the present invention will be described in detail by explaining exemplary embodiments of the invention with reference to the attached drawings. Like reference numerals in the drawings denote like elements.

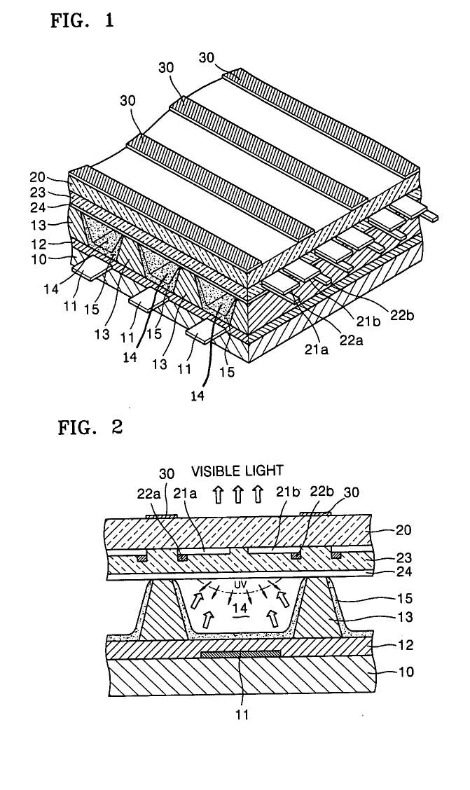

FIGS. 1 and 2 illustrate surface discharge plasma display panels. In FIG. 2, only an upper substrate, that is, a front substrate, is illustrated in a 90°-rotated state in order to clearly show an internal structure of the plasma display panel.

Referring to FIGS. 1 and 2, the plasma display panel comprises lower and upper substrates 10 and 20 facing each other.

A plurality of address electrodes 11 are provided in strips on an upper surface of the lower substrate 10. The address electrodes 11 are embedded in a first dielectric layer 12 made of a white dielectric material. A plurality of partitions 13 are provided in a predetermined interval on an upper surface of the first dielectric layer 12 in order to prevent electrical or optical crosstalk between discharge cells 14. Red (R), green (G) and blue (B) fluorescent layers 15 having a predetermined thickness are coated on inner surfaces of respective discharge cells 14 defined by the partitions 13. The discharge cells 14 are filled with a discharge gas which is generally a mixture of Ne and a small amount of Xe.

The upper substrate 20 is a transparent substrate, mainly made of glass, capable of passing visible rays of light. The upper substrate 20 is assembled with the lower substrate 10 provided with the partitions 13. On a lower surface of the upper substrate 20 are provided pairs of sustaining electrodes 21a and 21b in strips in a direction perpendicular to the address electrodes 11. The sustaining electrodes 21a and 21b are mainly made of a transparent, conductive material such as indium tin oxide (ITO), allowing the visible rays of light to pass. On lower surfaces of the sustaining electrodes 21a and 21b are provided bus electrodes 22a and 22b, made of metal, having a narrower width than those of the sustaining electrodes 12a and 12b in order to reduce line resistance thereof. The sustaining electrodes 21a and 21b and bus electrodes 22a and 22b are embedded in a second dielectric layer 23, which is a transparent layer. A protective layer 24 is provided on a lower surface of the second dielectric layer 23. The protective layer 24 has functions of preventing the second dielectric layer 23 deterioration due to sputtered plasma particles and reduces discharge and sustains voltages by emitting secondary electrons. The protective layer 24 is generally made of MgO. On an upper surface of the upper substrate 20 are provided black strips 30 in a predetermined interval in a direction parallel to the sustaining electrodes 21a and 21b in order to prevent external rays of light from entering the plasma display panel.

The driving scheme of the plasma display panel having the above structure is classified into address and sustaining driving schemes. In the address driving scheme, an address discharge is generated between the address electrode 11 and one sustaining electrode 21a, and wall charges are formed at this time. On the other hand, in the sustaining driving scheme, a sustaining discharge is generated by a potential difference between the sustaining electrodes 21a and 21b located at discharge cells 14 where the wall charges are formed. Ultraviolet rays of light emitted from a discharge gas during the sustaining discharge excite the fluorescent layer 15 in the discharge cell 14 to emit visible rays of light. The visible rays of light passing through the upper substrate 20 form an image which can be seen by the eyes of a user.

However, in the plasma display panel with such an arrangement, under a bright room condition where the exterior is brighter than the plasma display panel, external rays of light enters the discharge cells 14 of the plasma display panel, resulting in superposition of the external rays of light with the rays of light generated in the discharge cells 14. As a result, contrast is reduced in bright rooms. Therefore, image display performance of the plasma display panel is deteriorated.

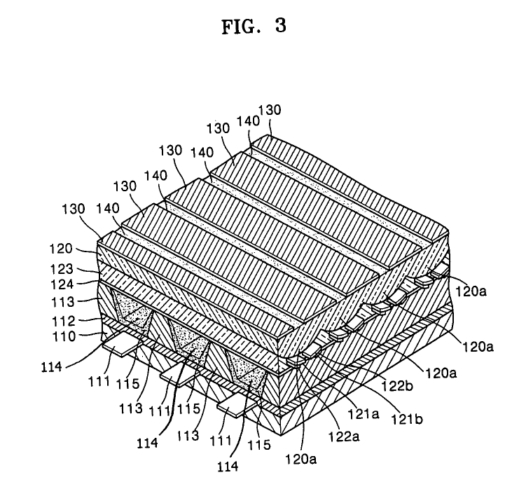

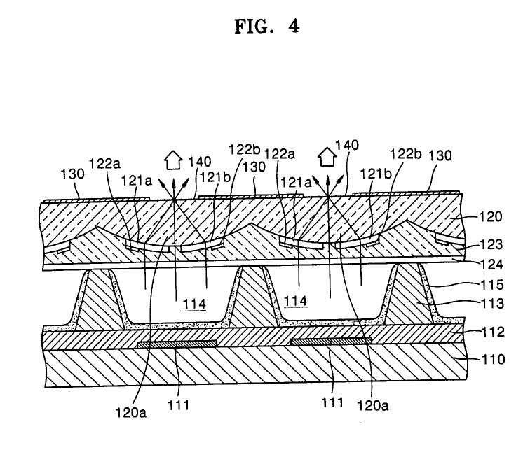

FIG. 3 is an exploded perspective view illustrating a surface discharge plasma display panel according to an exemplary embodiment of the present invention, and FIG. 4 is a cross sectional view of the plasma display panel of FIG. 3. In FIG. 4, only an upper substrate, that is, a front substrate, is illustrated in a 90°-rotated state in order to clearly show an internal structure of the plasma display panel.

The plasma display panel according to the present invention comprises lower and upper substrates 110 and 120 separated from and facing each other. Discharge cells 114 are provided between the lower and upper substrates 110 and 120 where a plasma discharge is generated.

A plurality of address electrodes 111 for an address discharge are provided in strips on an upper surface of the lower substrate 110, a glass substrate. A first dielectric layer 112 is also provided on the upper surface of the lower substrate 110 to cover the address electrodes 111. The first dielectric layer 112 having a predetermined thickness is formed by depositing a white dielectric material on the upper surface of the lower substrate 110.

A plurality of partitions 113 are provided in a predetermined interval on an upper surface of the first dielectric layer 112. The partitions define discharge cells 114 by partitioning a discharge space between the lower and upper substrates 110 and 120. The partitions 113 have a function of improving color purity by preventing electrical or optical crosstalk between the discharge cells 114. Each of red (R), green (G) and blue (B) fluorescent layers 115 having a predetermined thickness is coated on the upper surface of the first dielectric layer 112 and sidewalls of the partitions 113 in an inner surface of the corresponding discharge cell 114. Ultraviolet rays of light generated by a plasma discharge excite each of the fluorescent materials 115 to emit visible rays of light in a predetermined color. The discharge cells 114 are filled with a discharge gas used for the plasma discharge. The discharge gas is generally a mixture of Ne and a small amount of Xe.

The upper substrate 120 is a transparent substrate, mainly made of glass, allowing visible rays of light to pass. A plurality of light focusing elements 120a are provided on the upper substrate 120. The light focusing elements 120a corresponding to the discharge cells 114 are provided in strips on a lower surface of the upper substrate 120. In addition, the light focusing elements are formed to be convex on the lower surface of the upper substrate 120. The light focusing elements are provided in a direction perpendicular to the address electrodes 111. Each of the light focusing elements 120a functions as a micro lens for focusing and emitting visible rays of light generated in the discharge cells 114. Therefore, the lower surface of the upper substrate 120 has a lenticular shape where the micro lenses are formed to be convex in strips. With the light focusing elements 120a for focusing and emitting visible rays of light generated in the discharge cell 114 being provided on the upper substrate 120, it is possible to reduce loss of light and improve brightness.

A pair of first and second discharging electrodes 121a and 121b for sustaining discharge in each of the discharge cells 114 is provided on a lower surface of each of the light focusing elements 120a. First and second discharging electrodes 121a and 121b are formed in a longitudinal direction of the light focusing elements 120a. The first and second discharging electrodes 121a and 121b are mainly made of transparent conductive materials, such as ITO, allowing visible rays of light to pass. First and second bus electrodes 122a and 122b made of metal are provided on the lower surfaces of the first and second discharging electrodes 121a and 121b. The first and second bus electrodes 122a and 122b have a function of reducing line resistance of the first and second discharging electrodes 121a and 121b. The first and second bus electrodes 122a and 122b have narrower widths than those of the discharging electrodes 121a and 121b.

A second dielectric layer 123 is provided on the lower surface of the upper substrate 120 to cover the first and second discharging electrodes 121a and 121b and the first and second bus electrodes 122a and 122b. The second dielectric layer 123 may be formed by depositing a transparent dielectric material on a lower surface of the upper substrate 120.

A protective layer 124 is provided on a lower surface of the second dielectric layer 123. The protective layer 124 has a function of preventing the second dielectric layer 123 and the first and second discharging electrodes 121a and 121b from deteriorating due to sputtering of plasma particles. In addition, the protective layer 124 has a function of reducing a discharge voltage by emitting secondary electrons. The protective layer 124 may be formed by depositing magnesium oxide (MgO) with a predetermined thickness on the lower surface of the second dielectric layer 123.

A plurality of light shielding elements are provided on an upper surface of the upper substrate 120 to prevent external rays of light from entering the discharge cells 114 through the upper substrate 120. The light shielding elements comprise a plurality of black strips 130 provided in a predetermined interval on the upper substrate 120. The black strips 130 are provided in a direction perpendicular to the partitions 113, that is, a longitudinal direction of the light focusing elements 120a of the upper substrate 120. The black strips 130 are formed in a predetermined interval on the upper substrate 120 between the light focusing elements 120a. The visible rays of light generated in the discharge cells are focused on the upper surface 140 of the upper substrate 120 by the light focusing elements 120a. And then, the visible rays of light are diffused and emitted to the exterior, as shown in FIG. 4. In the present invention, the black strips 130 can be provided at the upper surface 140 of the upper substrate 120 where the visible rays of light generated in the discharge cells 114 are not emitted. Therefore, the black strips 130 can be formed wider than previously designed. As a result, it is possible to more effectively prevent external rays of light from entering the discharge cells 114. Therefore, the contrast in bright rooms can be improved.

The upper surfaces 140 of the upper substrate 120, from which the visible rays of light generated in the discharge cells 114 emit, are subjected to a non-glare process. The non-glare process is performed in order to avoid “eye dazzling effect” created with reflection of external rays of light on the upper substrate.

With the aforementioned arrangement of the plasma display panel, the address discharge is generated between the address electrode 111 and first discharging electrodes 121a. At this time, wall charges are generated. Next, when an AC voltage is applied to the first and second discharging electrodes 121a and 121b, a sustaining discharge is generated in the discharge cell 114 where the wall charges are formed. Ultraviolet rays of light generated from the discharge gas during the sustaining discharge excite fluorescent materials 115 to emit visible rays of light.

The visible rays of light generated in the discharge cells 114 are focused on the upper surface 140 of the non-glare upper substrate 120 between the black strips 130 by the light focusing elements 120a and then diffused and emitted to the exterior. Therefore, it is possible to reduce loss of visible rays of light generated in the discharge cells 114 and improve brightness.

In addition, since the ratio of coverage area of the black strips 130 formed on the upper surface 140 of the upper substrate 120 can be higher than that of other plasma display panels, it is possible to more effectively prevent external rays of light from entering the discharge cells. As a result, the bright room contrast of the plasma display panel can be improved. More specifically, when the ratio of the black strips is set as 50%, which is a limit value of conventional plasma display panels, the resulting value of the bright room contrast is 70:1. In the plasma display panel according to the present invention, when the ratio of the black strips is set as 60% and 70%, the resulting values of the bright room contrast are 130:1 and 197:1, respectively. Moreover, when the ratio of the black strips is set as 80%, which is a limit value of an embodiment of the plasma display panel according to the present invention, the resulting value of the bright room contrast is 300:1. Therefore, it can be understood that the bright room contrast in the plasma display panel according to the present invention is improved four times over that of conventional plasma display panels.

A plasma display panel according to embodiments of the present invention has advantages as follows.

Firstly, since visible rays of light generated in discharge cells are focused on an upper substrate and emitted to the exterior, it is possible to reduce loss of light and to improve brightness.

Secondly, since a ratio of black strips for preventing external rays of light from entering a plasma display panel can be higher than that of a conventional plasma display panel, it is possible to improve bright room contrast of the plasma display panel.

Thirdly, a compact plasma display panel can be manufactured by forming light focusing elements into a single body on the upper substrate without a need of using a separate light focusing unit, thereby reducing manufacturing costs.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A plasma display panel comprising:
lower and upper substrates separated from each other to form a discharge space therebetween;
a plurality of partitions provided between the lower and upper substrates to partition the discharge space to define discharge cells;
a plurality of first and second discharge electrodes generating a discharge within the discharge cells;
a plurality of fluorescent layers provided to inner surfaces of the discharge cells, each of the fluorescent layers being excited by the discharge to generate visible rays of light; and
a plurality of light shielding elements provided to the upper substrate to prevent external rays of light from entering the discharge cells,
wherein a plurality of light focusing elements are provided to the upper substrate to focus the visible rays of light generated in the discharge cells and emit visible light.

2. The plasma display panel according to claim 1, wherein the plurality of first and second discharge electrodes are located on surfaces of the plurality of light focusing elements.

3. The plasma display panel according to claim 1, wherein the plurality of light focusing elements are formed to be convex on a lower surface of the upper substrate.

4. The plasma display panel according to claim 3, wherein the plurality of light focusing elements are provided to corresponding discharge cells.

5. The plasma display panel according to claim 3, wherein the plurality of light focusing elements are formed in strips on the lower surface of the upper substrate.

6. The plasma display panel according to claim 5, wherein the plurality of light focusing elements are provided in a direction perpendicular to the plurality of partitions.

7. The plasma display panel according to claim 1, wherein the plurality of light shielding elements comprise a plurality of black strips provided in a predetermined interval on the upper substrate.

8. The plasma display panel according to claim 7, wherein the plurality of light focusing elements are disposed to focus the visible rays of light generated in the discharge cells on regions between the plurality of black strips.

9. The plasma display panel according to claim 8, wherein upper surfaces of the plurality of black strips are subjected to a non-glare process.

10. The plasma display panel according to claim 8, wherein the plurality of black strips are provided in a direction perpendicular to the plurality of partitions.

11. The plasma display panel according to claim 8, wherein the plurality of black strips are provided on the upper surface of the upper substrate.

12. The plasma display panel according to claim 1, wherein the discharge cells are filled with discharge gas.

13. The plasma display panel according to claim 12, wherein the discharge gas is a mixture of Ne and Xe.

14. A plasma display panel comprising:
lower and upper substrates separated from each other to form a discharge space therebetween;
a plurality of address electrodes provided in strips on an upper surface of the lower substrate;
a first dielectric layer provided on the upper surface of the lower substrate to cover the plurality of address electrodes;
a plurality of partitions provided on an upper surface of the first dielectric layer to partition the discharge space to define discharge cells;
a plurality of first and second discharge electrodes provided on a lower surface of the upper substrate in a direction perpendicular to the plurality of address electrodes;
a second dielectric layer provided on the lower surface of the upper substrate to cover the plurality of first and second discharge electrodes;
a plurality of fluorescent layers provided on upper surfaces of the first dielectric layer and sidewalls of the plurality of partitions constituting inner surfaces of the discharge cells; and
a plurality of light shielding elements provided to the upper substrate to prevent external rays of light from entering the discharge cells,
wherein a plurality of light focusing elements are provided to the upper substrate to focus visible rays of light generated in the discharge cells and emit visible light.

15. The plasma display panel according to claim 14, wherein the plurality of light focusing elements are formed to be convex on a lower surface of the upper substrate.

16. The plasma display panel according to claim 15, wherein the plurality of light focusing elements are provided to corresponding discharge cells.

17. The plasma display panel according to claim 15, wherein the plurality of light focusing elements are formed in strips on the lower surface of the upper substrate.

18. The plasma display panel according to claim 17, wherein the plurality of light focusing elements are provided in a direction perpendicular to the plurality of partitions.

19. The plasma display panel according to claim 14, wherein the plurality of light shielding elements comprise a plurality of black strips provided in a predetermined interval on the upper substrate.

20. The plasma display panel according to claim 19, wherein the plurality of light focusing elements are disposed to focus the visible rays of light generated in the discharge cells on regions between the plurality of black strips.

21. The plasma display panel according to claim 20, wherein upper surfaces of the plurality of black strips are subjected to a non-glare process.

22. The plasma display panel according to claim 20, wherein the plurality of black strips are provided in a direction perpendicular to the plurality of partitions.

23. The plasma display panel according to claim 20, wherein the plurality of black strips are provided on the upper surface of the upper substrate.

24. The plasma display panel according to claim 17, wherein the plurality of first and second discharge electrodes are provided on a lower surface of the plurality of light focusing elements.

25. The plasma display panel according to claim 24, wherein the plurality of first and second discharge electrodes extend in a longitudinal direction of the plurality of light focusing elements.

26. The plasma display panel according to claim 25, wherein first and second bus electrodes are provided on a lower surface of the plurality of first and second discharge electrodes.

27. The plasma display panel according to claim 14, wherein a protective layer is provided on a lower surface of the second dielectric layer.

28. The plasma display panel according to claim 14, wherein the discharge cells are filled with discharge gas.

29. The plasma display panel according to claim 28, wherein the discharge gas is a mixture of Ne and Xe.

30. A plasma display panel, comprising:
lower and upper substrates;
a plurality of partitions provided between said lower and upper substrates defining discharge cells;
a plurality of discharge electrodes generating a discharge within said discharge cells;
a plurality of fluorescent layers generating visible rays of light when excited by said discharge; and
a plurality of light shielding elements preventing external rays of light from entering said discharge cells,
wherein a plurality of light focusing elements are adaptable to focus said visible rays of light to emit visible light from said plasma display panel.
